(19) United States
(12) Patent Application Publication
(10) Pub. No.: US 2009/0198910 A1
(43) Pub. Date: Aug. 6, 2009

(54) DATA PROCESSING SYSTEM, PROCESSOR AND METHOD THAT SUPPORT A TOUCH OF A PARTIAL CACHE LINE OF DATA

(76) Inventors: RAVI K. ARIMILLI, Austin, TX (US); Gheorghe C. Cascaval, Carmel, NY (US); Balaram Sinharoy, Poughkeepsie, NY (US); William E. Speight, Austin, TX (US); Lixin Zhang, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 12/024,174

(22) Filed: Feb. 1, 2008

(51) Int. Cl. G06F 12/00

(52) U.S. Cl. 711/141; 711/E12.001

(57) ABSTRACT

According to method of data processing in a multiprocessor data processing system, in response to a processor touch request targeting a target granule of a cache line of data containing multiple granules, a processing unit originates on an interconnect of the multiprocessor data processing system a partial touch request that requests a copy of only the target granule for subsequent query access. In response to a combined response to the partial touch request indicating success, the combined response representing a system-wide response to the partial touch request, the processing unit receives the target granule of the target cache line and updates a coherency state of the target granule while retaining a coherency state of at least one other granule of the cache line.

This invention was made with United States Government support under Agreement No. HR0011-07-9-0002 awarded by DARPA. The Government has certain rights in the invention.

### BACKGROUND OF THE INVENTION

1. Technical Field

The present invention relates in general to data processing and, in particular, coherency management and interconnect operations for partial cache lines of data within a data processing system.

2. Description of the Related Art

A conventional symmetric multiprocessor (SMP) computer system, such as a server computer system, includes multiple processing units all coupled to a system interconnect, which typically comprises one or more address, data and control buses. Coupled to the system interconnect is a system memory, which represents the lowest level of volatile memory in the SMP computer system and which generally is accessible for read and write access by all processing units. In order to reduce access latency to instructions and data residing in the system memory, each processing unit is typically further supported by a respective multi-level cache memory hierarchy, the lower level(s) of which may be shared by one or more processor cores.

Data in a conventional SMP computer system is frequently accessed and managed as a “cache line,” which refers to a set of bytes that are stored together in an entry of a cache memory and that may be referenced utilizing a single address. The cache line size may, but does not necessarily correspond to the size of memory blocks employed by the system memory. The present invention appreciates that memory accesses in a conventional SMP data processing system, which access an entire cache line, can lead to system inefficiencies, including significant traffic on the system interconnect and undesirable cross-invalidation of cached data.

### SUMMARY OF THE INVENTION

According to one embodiment of a method of data processing in a multiprocessor data processing system, in response to a processor touch request targeting a target granule of a cache line of data containing multiple granules, a processing unit originates on an interconnect of the multiprocessor data processing system a partial touch request that requests a copy of only the target granule for subsequent query access. In response to a combined response to the partial touch request indicating success, the combined response representing a system-wide response to the partial touch request, the processing unit receives the target granule of the target cache line and updates a coherency state of the target granule while retaining a coherency state of at least one other granule of the cache line.

### BRIEF DESCRIPTION OF THE DRAWINGS

FIG. 1 is a high level block diagram of a multiprocessor data processing system in accordance with the present invention;

FIG. 2 is a high level block diagram of an exemplary processing unit in the multiprocessor data processing system of FIG. 1;

FIG. 3 is a more detailed block diagram of a cache array and directory in accordance with the present invention;

FIG. 4 is a time-space diagram of an exemplary operation within the multiprocessor data processing system of FIG. 1;

FIG. 5 is a high level logical flowchart illustrating exemplary operation of a cache master according to an embodiment of the present invention;

FIG. 6 is a high level logical flowchart illustrating exemplary operation of a cache snooper according to an embodiment of the present invention;

FIG. 7 is a high level logical flowchart illustrating exemplary operation of a memory controller snooper according to an embodiment of the present invention;

FIG. 8 is a more detailed block diagram of the data prefetch unit of FIG. 1;

FIG. 9 is a high level logical flowchart depicting an exemplary process by which stream registers are allocated by a data prefetch unit according to an embodiment of the present invention; and

FIG. 10 is a high level logical flowchart depicting exemplary operation of a data prefetch unit according to an embodiment of the present invention.

### DETAILED DESCRIPTION OF ILLUSTRATIVE EMBODIMENT

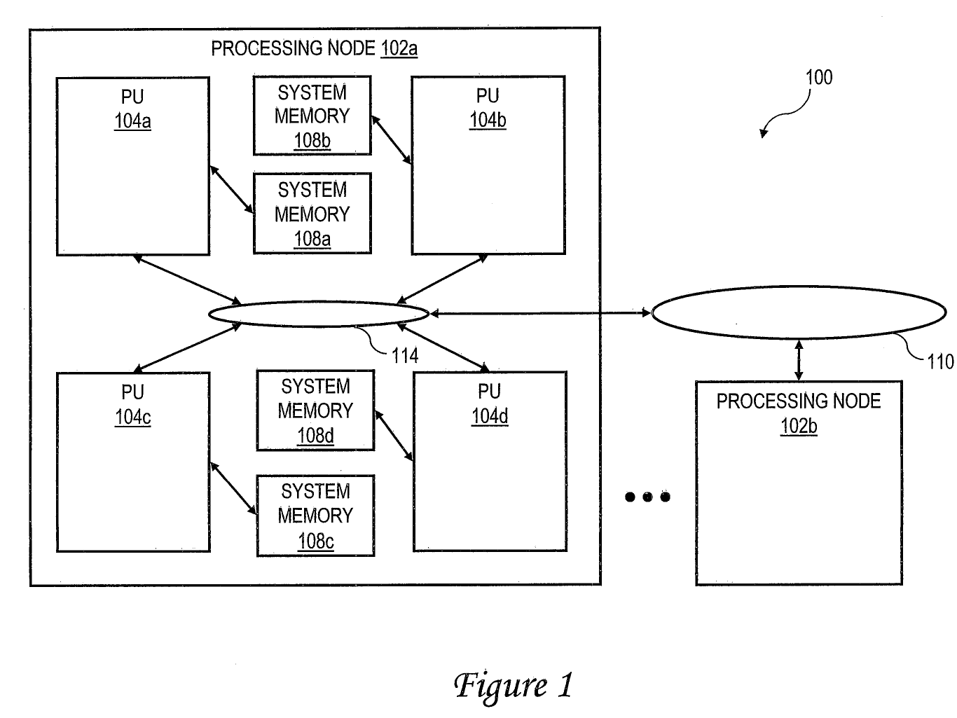

With reference now to the figures and, in particular, with reference to FIG. 1, there is illustrated a high level block diagram of an exemplary embodiment of a multiprocessor data processing system in accordance with the present invention. As shown, data processing system 100 includes multiple processing nodes 102a, 102b for processing data and instructions. Processing nodes 102a, 102b are coupled to a system interconnect 110 for conveying address, data and control information. System interconnect 110 may be implemented, for example, as a bused interconnect, a switched interconnect or a hybrid interconnect.

In the depicted embodiment, each processing node 102 is realized as a multi-chip module (MCM) containing four processing units 104a-104d, each preferably realized as a respective integrated circuit. The processing units 104a-104d within each processing node 102 are coupled for communication by a local interconnect 114, which, like system interconnect 110, may be implemented with one or more buses and/or switches.

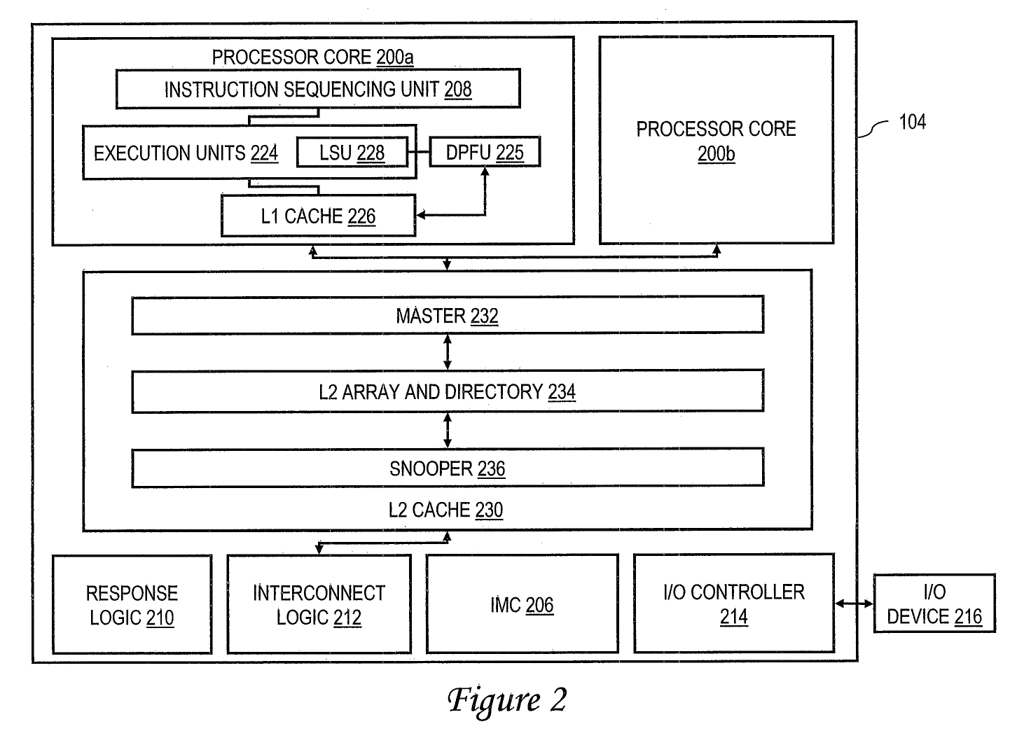

The devices coupled to each local interconnect 114 include not only processing units 104, but also one or more system memories 108a-108d. Data and instructions residing in system memories 108 can generally be accessed and modified by a processor core 200 (FIG. 2) in any processing unit 104 in any processing node 102 of data processing system 100. In alternative embodiments of the invention, one or more system memories 108 can be coupled to system interconnect 110 rather than a local interconnect 114.

Those skilled in the art will appreciate that data processing system 100 can include many additional unillustrated components, such as interconnect bridges, non-volatile storage, ports for connection to networks or attached devices, etc. Because such additional components are not necessary for an understanding of the present invention, they are not illustrated in FIG. 1 or discussed further herein. It should also be understood, however, that the enhancements provided by the present invention are applicable to data processing systems of diverse architectures and are in no way limited to the generalized data processing system architecture illustrated in FIG. 1.

Referring now to FIG. 2, there is depicted a more detailed block diagram of an exemplary processing unit 104 in accordance with the present invention. In the depicted embodiment, each processing unit 104 includes two processor cores 200a, 200b for independently processing instructions and data. Each processor core 200 includes at least an instruction sequencing unit (ISU) 208 for fetching and ordering instructions for execution and one or more execution units 224 for executing instructions. The instructions executed by execution units 224 include instructions that request access to a memory block or cause the generation of a request for access to a memory block, and execution units 224 include a load-store unit (LSU) 228 that executes memory access instructions (e.g., storage-modifying and non-storage-modifying instructions). Each processor core 200 further preferably includes a data prefetch unit (DPFU) 225 that prefetches data in advance of demand.

The operation of each processor core 200 is supported by a multi-level volatile memory hierarchy having at its lowest level shared system memories 108a-108d, and at its upper levels one or more levels of cache memory. In the depicted embodiment, each processing unit 104 includes an integrated memory controller (IMC) 206 that controls read and write access to a respective one of the system memories 108a-108d within its processing node 102 in response to requests received from processor cores 200a-200b and operations snooped by a snooper (S) 222 on the local interconnect 114.

In the illustrative embodiment, the cache memory hierarchy of processing unit 104 includes a store-through level one (L1) cache 226 within each processor core 200 and a level two (L2) cache 230 shared by all processor cores 200a, 200b of the processing unit 104. L2 cache 230 includes an L2 array and directory 234, as well as a cache controller comprising a master 232 and a snooper 236. Master 232 initiates transactions on local interconnect 114 and system interconnect 110 and accesses L2 array and directory 234 in response to memory access (and other) requests received from the associated processor cores 200a-200b. Snooper 236 snoops operations on local interconnect 114, provides appropriate responses, and performs any accesses to L2 array and directory 234 required by the operations.

Although the illustrated cache hierarchy includes only two levels of cache, those skilled in the art will appreciate that alternative embodiments may include additional levels (L3, L4, etc.) of on-chip or off-chip in-line or lookaside cache, which may be fully inclusive, partially inclusive, or non-inclusive of the contents the upper levels of cache.

Each processing unit 104 further includes an instance of response logic 210, which as discussed further below, implements a portion of the distributed coherency signaling mechanism that maintains cache coherency within data processing system 100. In addition, each processing unit 104 includes an instance of forwarding logic 212 for selectively forwarding communications between its local interconnect 114 and system interconnect 110. Finally, each processing unit 104 includes an integrated I/O (input/output) controller 214 supporting the attachment of one or more I/O devices, such as I/O device 216. I/O controller 214 may issue operations on local interconnect 114 and/or system interconnect 110 in response to requests by I/O device 216.

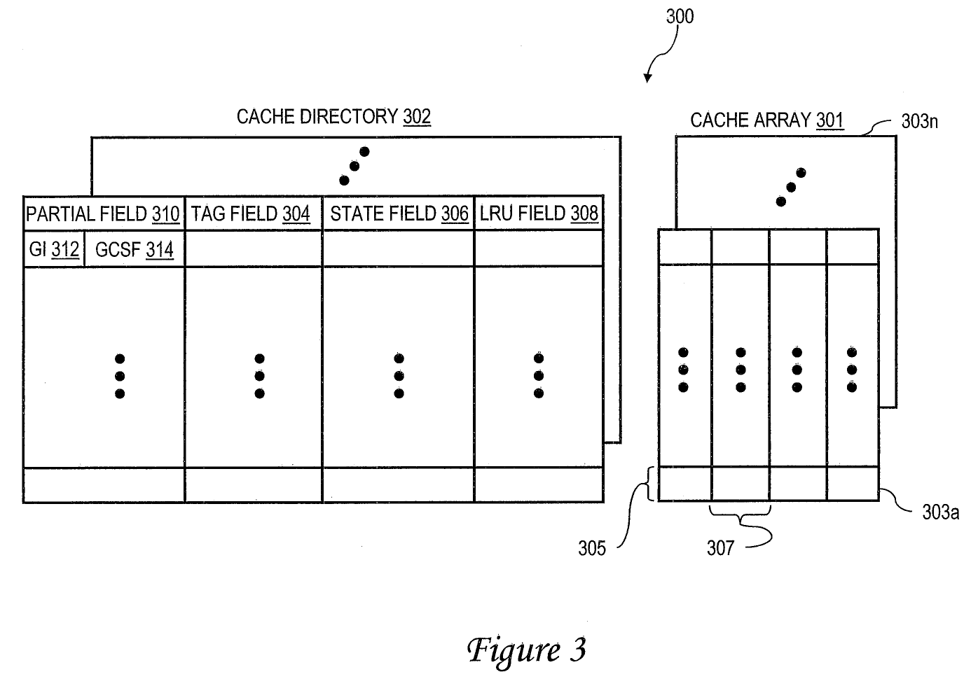

With reference now to FIG. 3, there is illustrated a more detailed block diagram of an exemplary embodiment of a cache array and directory 300, which may be utilized, for example, to implement the cache array and directory of an L1 cache 226 or L2 cache array and directory 234. As illustrated, cache array and directory 300 includes a set associative cache array 301 including multiple ways 303a-303n. Each way 303 includes multiple entries 305, which in the depicted embodiment each provide temporary storage for up to a full memory block of data, e.g., 128 bytes. Each cache line or memory block of data is logically formed of multiple granules 307 (in this example, four granules of 32 bytes each) that may correspond in size, for example, to the smallest allowable access to system memories 108a-108d. In accordance with the present invention, granules 307 may be individually accessed and cached in cache array 301.

Cache array and directory 300 also includes a cache directory 302 of the contents of cache array 301. As in conventional set associative caches, memory locations in system memories 108 are mapped to particular congruence classes within cache arrays 301 utilizing predetermined index bits within the system memory (real) addresses. The particular cache lines stored within cache array 301 are recorded in cache directory 302, which contains one directory entry for each cache line in cache array 301. As understood by those skilled in the art, each directory entry in cache directory 302 comprises at least a tag field 304, which specifies the particular cache line stored in cache array 300 utilizing a tag portion of the corresponding real address, a LRU (Least Recently Used) field 308 indicating a replacement order for the cache line with respect to other cache lines in the same congruence class, and a line coherency state field 306, which indicates the coherency state of the cache line.

In at least some embodiments, cache directory 302 further includes a partial field 310, which in the depicted embodiment includes granule identifier (GI) 312 and granule coherency state field (GCSF) 314. Partial field 310 supports caching of partial cache lines in cache array 301 and appropriate coherency management by identifying with granule identifier 312 which granule(s) of the cache line is/are associated with the coherency state indicated by granule coherency state field 314. For example, GI 312 may identify a particular granule utilizing 2ⁿ bits (where n is the total number of granules 307 per cache line) or may identify one or more granules utilizing a one-hot or multi-hot encoding (or some other alternative encoding).

Coherency states that may be utilized in line coherency state field 306 and granule coherency state field 314 to indicate state information may be defined by the well-known MESI coherency protocol or a variant thereof. An exemplary variant of the MESI protocol that may be employed is described in detail in U.S. patent application Ser. No. 11/055,305, which is incorporated herein by reference. In some embodiments, when GI 312 indicates that fewer than all granules of a cache line are held in the associated entry 305 of cache array 301, granule coherency state field 314 indicates a special “Partial” coherency state that indicates that less than the complete cache line is held by cache array 301. For coherency management purposes, a Partial coherency state, if implemented, functions as a shared coherency state, in that data from such a cache line can be read freely, but cannot be modified without notification to other L2 cache memories 230 that may hold one or more granules 307 of the same cache line.

It should be appreciated that although partial field 310 is illustrated as part of cache directory 302, the information in partial field 310 could alternatively be maintained in separate directory structure to achieve lower latency access and/or other architectural considerations.

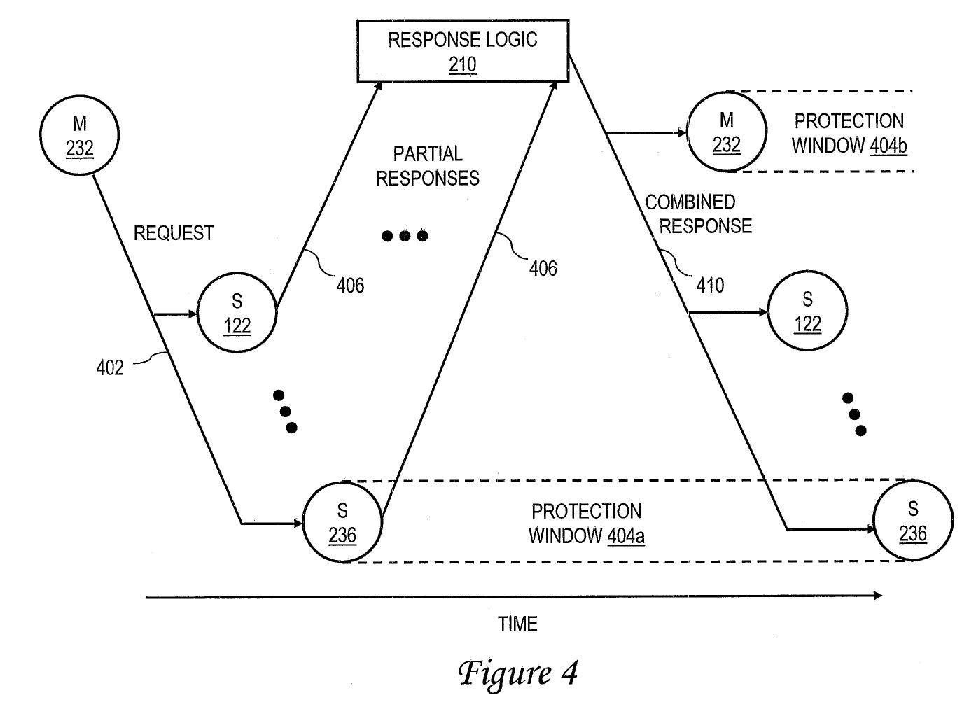

Referring now to FIG. 4, there is depicted a time-space diagram of an exemplary interconnect operation on a local or system interconnect 110, 114 of data processing system 100 of FIG. 1. The interconnect operation begins when a master 232 of an L2 cache 230 (or another master, such as an I/O controller 214) issues a request 402 of the interconnect operation on a local interconnect 114 and/or system interconnect 110. Request 402 preferably includes at least a transaction type indicating a type of desired access and a resource identifier (e.g., real address) indicating a resource to be accessed by the request. Conventional types of requests that may be issued on interconnects 114, 110 include those set forth below in Table I.

TABLE I

| Request | Description |
|---|---|
| READ | Requests a copy of the image of a memory block for query |
| | purposes |
| RWITM (Read- | Requests a unique copy of the image of a memory block with the |
| With-Intent-To- | intent to update (modify) it and requires destruction of other |
| Modify) | copies, if any |
| DCLAIM (Data | Requests authority to promote an existing query-only copy of |
| Claim) | memory block to a unique copy with the intent to update (modify) |
| | it and requires destruction of other copies, if any |
| DCBT (Data Cache | Requests a copy of the image of memory block in advance of need |
| Block Touch) | |
| CASTOUT | Copies the image of a memory block from a higher level of |
| | memory to a lower level of memory in preparation for the |
| | destruction of the higher level copy |
| WRITE | Requests authority to create a new unique copy of a memory |
| | block without regard to its present state and immediately copy the |
| | image of the memory block from a higher level memory to a |
| | lower level memory in preparation for the destruction of the |
| | higher level copy |

As described further below, conventional requests such as those listed in Table I are augmented according to the present invention by one or more additional memory access request types that target partial rather than full memory blocks of data.

Request 402 is received by the snooper 236 of L2 caches 230, as well as the snoopers 222 of memory controllers 206 (FIG. 2). In general, with some exceptions, the snooper 236 in the same L2 cache 230 as the master 232 of request 402 does not snoop request 402 (i.e., there is generally no self-snooping) because a request 402 is transmitted on local interconnect 114 and/or system interconnect 110 only if the request 402 cannot be serviced internally by a processing unit 104. Each snooper 222, 236 that receives request 402 provides a respective partial response 406 representing the response of at least that snooper to request 402. A snooper 222 within a memory controller 206 determines the partial response 406 to provide based, for example, whether the snooper 222 is responsible for the request address and whether it has resources available to service the request. A snooper 236 of an L2 cache 230 may determine its partial response 406 based on, for example, the availability of its L2 cache directory 302, the availability of a snoop logic instance within snooper 236 to handle the request, and the coherency state associated with the request address in L2 cache directory 302.

The partial responses of snoopers 222 and 236 are logically combined either in stages or all at once by one or more instances of response logic 210 to determine a system-wide combined response (CR) 410 to request 402. Subject to any scope restrictions, response logic 210 provides combined response 410 to master 232 and snoopers 222, 236 via its local interconnect 114 and/or system interconnect 110 to indicate the system-wide response (e.g., success, failure, retry, etc.) to request 402. If CR 410 indicates success of request 402, CR 410 may indicate, for example, a data source for a requested memory block, a cache state in which the requested memory block is to be cached by master 232, and whether “cleanup” operations invalidating the requested memory block in one or more L2 caches 230 are required.

In response to receipt of combined response 410, one or more of master 232 and snoopers 222, 236 typically perform one or more operations in order to service request 402. These operations may include supplying data to master 232, invalidating or otherwise updating the coherency state of data cached in one or more L2 caches 230, performing castout operations, writing back data to a system memory 108, etc. If required by request 402, a requested or target memory block may be transmitted to or from master 232 before or after the generation of combined response 410 by response logic 210.

In the following description, partial response of a snooper 222, 236 to a request and the operations performed the snooper in response to the request and/or its combined response will be described with reference to whether that snooper is a Highest Point of Coherency (HPC), a Lowest Point of Coherency (LPC), or neither with respect to the request address specified by the request. An LPC is defined herein as a memory device or I/O device that serves as the repository for a memory block. In the absence of a HPC for the memory block, the LPC holds the true image of the memory block and has authority to grant or deny requests to generate an additional cached copy of the memory block. For a typical request in the data processing system embodiment of FIGS. 1 and 2, the LPC will be the memory controller 206 for the system memory 108 holding the referenced memory block. An HPC is defined herein as a uniquely identified device that caches a true image of the memory block (which may or may not be consistent with the corresponding memory block at the LPC) and has the authority to grant or deny a request to modify the memory block (or a granule 307 thereof). Descriptively, the HPC may also provide a copy of the memory block to a requestor in response to an operation that does not modify the memory block. Thus, for a typical request in the data processing system embodiment of FIGS. 1 and 2, the HPC, if any, will be an L2 cache 230. Although other indicators may be utilized to designate an HPC for a memory block, a preferred embodiment of the present invention designates the HPC, if any, for a memory block utilizing selected cache coherency state(s) within the L2 cache directory 302 of an L2 cache 230.

Still referring to FIG. 4, in at least some embodiments, the HPC, if any, for a memory block referenced in a request 402, or in the absence of an HPC, the LPC of the memory block, has the responsibility of protecting the transfer of coherency ownership of a memory block in response to a request 402 during a protection window 404a. In the exemplary scenario shown in FIG. 4, the snooper 236 that is the HPC for the memory block specified by the request address of request 402 protects the transfer of coherency ownership of the requested memory block to master 232 during a protection window 404a that extends from the time that snooper 236 determines its partial response 406 until snooper 236 receives combined response 410. During protection window 404a, snooper 236 protects the transfer of ownership by providing partial responses 406 to other requests specifying the same request address that prevent other masters from obtaining ownership until ownership has been successfully transferred to master 232. Master 232 likewise initiates a protection window 404b to protect its ownership of the memory block requested in request 402 following receipt of combined response 410.

Because snoopers 222, 236 all have limited resources for handling the CPU and I/O requests described above, several different levels of partial responses and corresponding CRs are possible. For example, if a snooper 222 within a memory controller 206 that is responsible for a requested memory block has queue available to handle a request, the snooper 222 may respond with a partial response indicating that it is able to serve as the LPC for the request. If, on the other hand, the snooper 222 has no queue available to handle the request, the snooper 222 may respond with a partial response indicating that is the LPC for the memory block, but is unable to currently service the request.

Similarly, a snooper 236 in an L2 cache 230 may require an available instance of snoop logic and access to L2 cache directory 302 in order to handle a request. Absence of access to either (or both) of these resources results in a partial response (and corresponding CR) signaling an inability to service the request due to absence of a required resource.

The present invention appreciates that, for at least some workloads, data processing system efficiency can be increased by utilizing “partial” memory access requests that target less than a full cache line of data (e.g., a specified target granule of a cache line of data). For example, if memory access requests occasioned by storage-modifying instructions can be tailored to target a specific granule of interest in a target cache line, the amount of cached data subject to cross-invalidation as a consequence of the storage-modifying instructions is reduced. As a result, the percentage of memory access requests that can be serviced from local cache increases (lowering average memory access latency) and fewer memory access requests are required to be issued on the interconnects (reducing contention).

To facilitate utilization of partial memory access operations, various embodiments of the present invention preferably permit partial memory access operations to be originated in one or more of a variety of ways. First, a master in the data processing system (e.g., a master 232 of an L2 cache 230) may initiate a partial memory access request in response to execution by an affiliated processor core 200 of an explicit “partial” memory access instruction that specifies access to less than all granules of a target cache line of data. Second, a master may initiate a partial memory access request based upon a software hint (e.g., supplied by the compiler) in the object code. Third, a master may initiate a partial memory access request based upon a dynamic detection of memory access patterns by hardware in the data processing system.

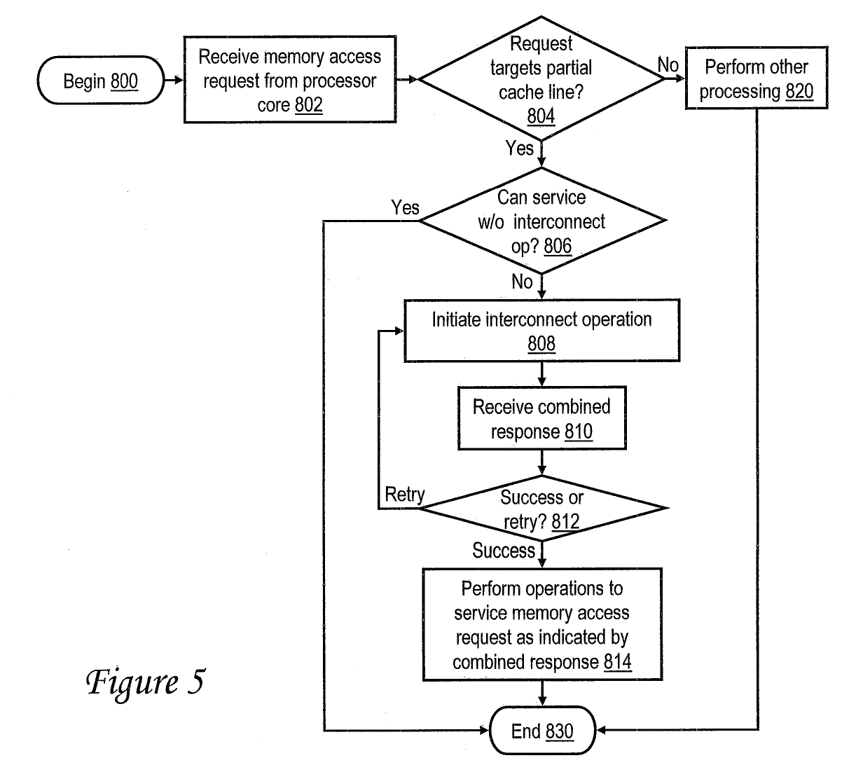

With reference now to FIG. 5, there is depicted a high level logical flowchart depicting exemplary operation of master 232 of an L2 cache 230 of FIG. 2 in response to receipt of a memory access request from an affiliated processor core 200 in the same processing unit 104. For ease of explanation, it will be assumed hereafter that the possible coherency states that may be assumed by granule coherency state field 314 are the same as those of line coherency state field 306.

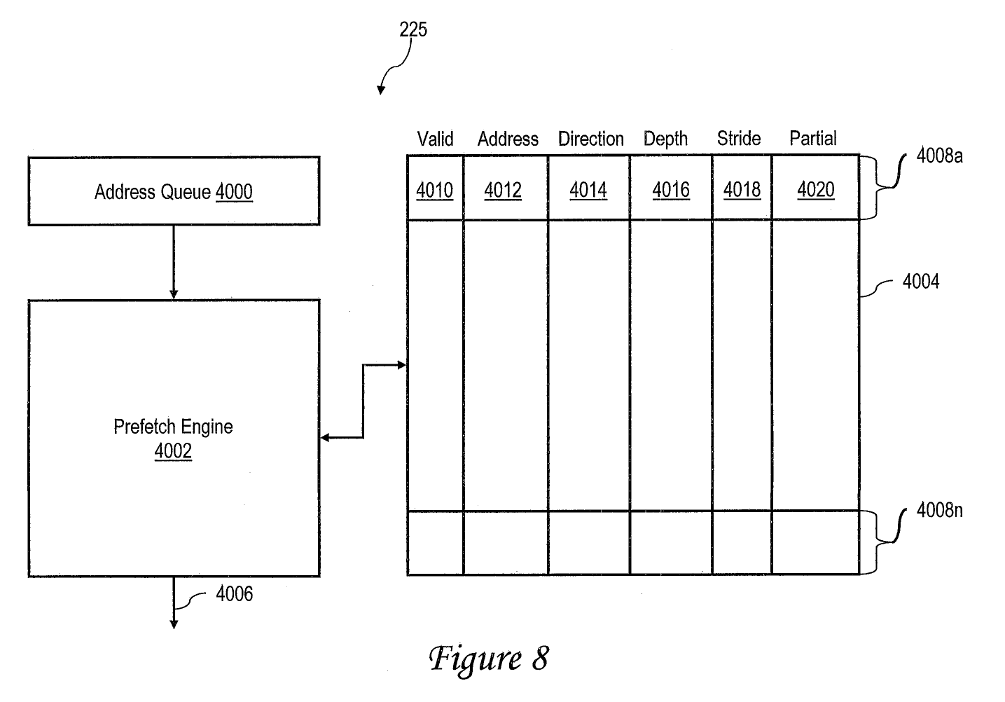

The process depicted in FIG. 8 begins at block 800 and proceeds to block 802, which illustrates master 232 receiving a processor memory access request, such as a data cache block touch (DCBT) request, from an affiliated processor core, such as processor core 200a of its processing unit 104. A DCBT instruction allows a program to explicitly request demand fetching of a memory block before it is actually needed by the program. In at least some embodiments, the DCBT instruction includes a hint field that permits the programmer and/or compiler to mark the DCBT instruction as a partial DCBT, meaning that the requested memory access targets less than a full cache line of data (e.g., a single granule 307). Upon execution of the DCBT instruction by the processor core 200 to determine the target address, the processor core 200 preferably transmits the DCBT request (including the hint field) and the target address to master 232.

The process next proceeds to block 804, which depicts master 232 determining if the DCBT request received at block 802 is a partial cache line memory access request (i.e., a partial DCBT), for example, by reference to the hint field of the DCBT request. If master 232 determines at block 804 that the memory access request received at block 802 is not a partial cache line memory access request, master 232 performs other processing to service the memory access request, as depicted at block 820. Thereafter, the process terminates at block 830.

Returning to block 804, if master 232 determines that the DCBT request is a partial cache line memory access request, the process proceeds to block 806. Block 806 illustrates master 232 determining whether the DCBT request can be serviced without issuing an interconnect operation on interconnect 114 and/or interconnect 110, for example, based upon the request type indicated by the memory access request and the coherency state associated with the target address of the memory access request within line coherency state field 306 and/or granule coherency state field 314 of cache directory 302. For example, as will be appreciated, master 232 generally can satisfy a partial cache line non-storage-modifying request such as a partial DCBT without issuing an interconnect operation if line coherency state field 306 or granule coherency state field 314 indicates any data-valid coherency state for the target granule 307 of the target cache line.

If master 232 determines at block 806 that the partial DCBT request can be serviced without issuing an interconnect operation, the process terminates at block 830. Returning to block 806, in response to master 232 determining that the partial DCBT request cannot be serviced without issuing an interconnect operation, the process proceeds to block 808. Block 808 illustrates master 232 initiating a partial DCBT interconnect operation by issuing a partial DCBT request that requests a copy of the image of the target granule for subsequent querying. In general, the partial DCBT interconnect operation includes a transaction type indicating a partial DCBT request, a target address, and a granule identifier that identifies the target granule of the target cache line. In at least some embodiments, the transaction granule identifier may alternatively or additionally be provided separately from the request phase of an interconnect operations, for example, with the combined response and/or at data delivery.

Following block 808, the process continues to block 810, which depicts master 232 receiving a combined response 410 from response logic 210 (FIG. 2). As previously discussed, the combined response is generated by response logic 210 from partial responses 406 of snoopers 236 and 222 within data processing system 100 and represents a system wide response to the partial DCBT request.

The process continues to block 812, which shows master 232 determining if the combined response 410 includes an indication of a “success” or “retry”. If the combined response 410 includes an indication of a “retry” (that the request cannot be fulfilled at the current time and must be retried), the process returns to block 808, which has been described. If the combined response 410 includes an indication of a “success” (that the request can be fulfilled at the current time), the process continues to block 814, which illustrates master 232 performing operations to service the memory access request, as indicated by the combined response 410.

For a partial DCBT interconnect operation, master 232 receives a copy of the requested target granule data from interconnect 114, caches the target granule in cache array 301, and updates cache directory 302. In updating cache directory 302, master 232 sets granule indicator 312 to identify the target granule 307, sets granule coherency state field 314 to the data-valid coherency state indicated by the combined response 410, and sets line coherency state field 306 to a data-invalid coherency state (e.g., the MESI Invalid state). Following block 814, the exemplary process depicted in FIG. 8 terminates at block 830.

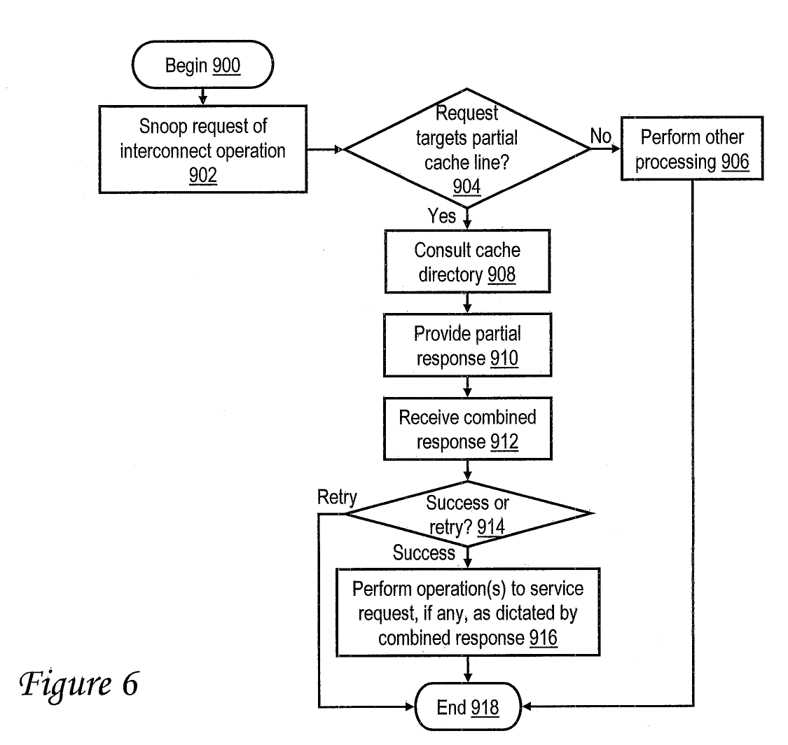

Referring now to FIG. 6, there is depicted is a high level logical flowchart depicting exemplary operation of a snooper 236 of an L2 cache 230 of FIG. 2. The process begins at block 900 and then proceeds to block 902, which illustrates snooper 236 snooping the request of an interconnect operation (e.g., a partial DCBT request) from interconnect 114 or 110. The process next proceeds to block 904, which depicts snooper 236 determining, for example, based upon the transaction type specified by the request, if the request targets a partial cache line. If snooper 236 determines at block 904 that the request does not belong to an interconnect operation targeting a partial cache line, the process continues to block 906, which shows snooper 236 performing other processing to handle the snooped request. The process thereafter ends at block 918.

Returning to block 904, if the snooped request targets a partial cache line rather than a full cache line of data, the process continues to block 908. Block 908 illustrates snooper 236 determining whether or not cache directory 302 indicates that cache array 301 holds the target granule in a data-valid coherency state. Based at least partly upon the directory lookup, snooper 236 generates and transmits a partial response 406. The partial response 406 may indicate, for example, the ability of snooper 236 to source requested read data by cache-to-cache data intervention or that the request address missed in cache directory 302. The process continues to block 912, which illustrates snooper 236 receiving the combined response 410 of the interconnect operation from response logic 210. The process continues to block 914, which shows snooper 236 determining whether the combined response 410 includes an indication of a “success” or “retry”. If combined response 410 includes an indication of a “retry” (that the request cannot be serviced at the current time and must be retried), the process simply terminates at block 918, and snooper 236 awaits receipt of the retried request.

If, however, snooper 236 determines at block 914 that the combined response 410 for the snooped partial cache line memory access request includes an indication of “success” (meaning that the request can be serviced at the current time), the process continues to block 916. Block 916 illustrates snooper 236 performing one or more operations, if any, to service the partial cache line memory access request as indicated by the combined response 410.

For example, if the request of the interconnect operation was a partial DCBT, at least two outcomes are possible. First, the L2 cache 230 of snooper 236 may not hold the target granule in its L2 array and directory 234 in a coherency state from which snooper 236 can source the target granule by cache-to-cache data intervention. In this case, snooper 236 takes no action in response to the combined response 410.

Second, if L2 cache 230 of snooper 236 holds the target granule in its L2 array and directory 234 in a coherency state from which snooper 236 can source the target granule by cache-to-cache data intervention, snooper 236 only sources the target granule 307 to the requesting master 232 by cache-to-cache intervention. In this second case, snooper 236 also makes an update to granule coherency state field 314, if required by the selected coherency protocol. For example, snooper 236 may demote the coherency state of its copy of the target granule from an HPC coherency state to a query-only coherency state. The overall coherency state of the cache line reflected in line coherency state field 306 remains unchanged, however, meaning that the other (i.e., non-target) granules of the target cache line may be retained in an HPC coherency state in which they may be modified by the local processing units 200 without issuing an interconnect operation.

In at least some embodiments, if snooper 236 delivers partial data in response to a snooped request, snooper 236 supplies in conjunction with the partial data a granule identifier indicating the position of the target granule 307 in the target cache line

Following block 916, the exemplary process depicted in FIG. 6 terminates at block 918.

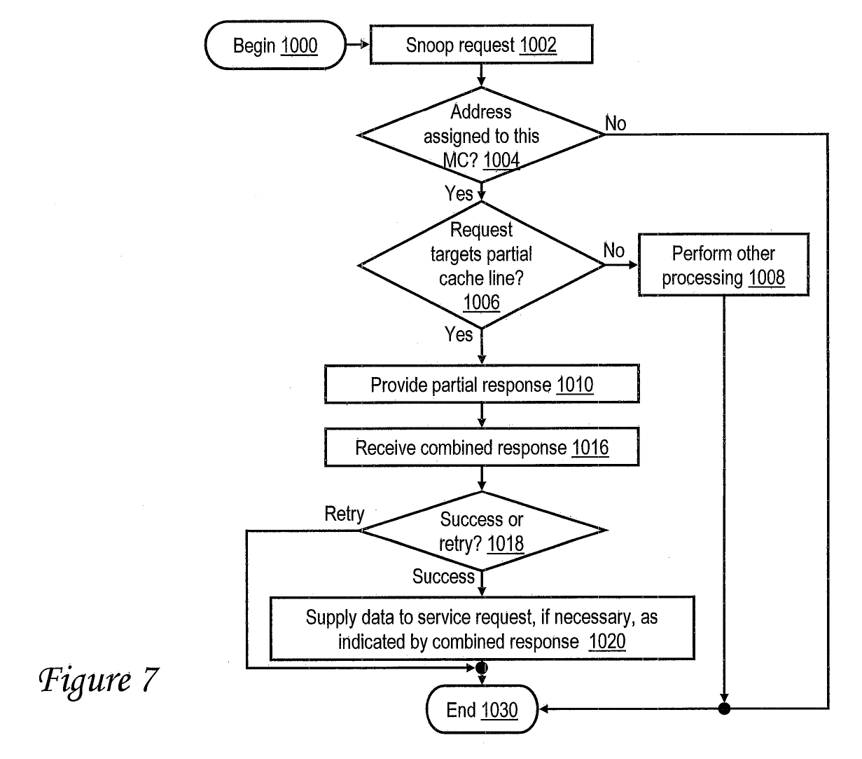

With reference now to FIG. 7, there is illustrated a high level logical flowchart depicting exemplary operation of snooper 222 within integrated memory controller 206 of FIG. 2. The process begins at block 1000 and proceeds to block 1002, which illustrates snooper 222 snooping a request on one of interconnects 114, 110. The process proceeds to block 1004, which depicts snooper 222 determining if the target address specified by the request is assigned to a system memory 108 controlled by the snooper's integrated memory controller 206. If not, the process terminates at block 1030. If, however, snooper 222 determines at block 1004 that the target address is assigned to a system memory 108 controlled by the snooper's integrated memory controller 206, snooper 222 also determines if the request is a memory access request that targets a partial cache line of data, such as a partial DCBT (block 1006). If not, the process proceeds to block 1008, which depicts snooper 222 performing other processing to service the memory access request. Thereafter, the process terminates at block 1030.

Returning to block 1006, if snooper 222 determines that the request is a memory access request such as a partial DCBT, which targets a partial cache line, the process proceeds to block 1010. Block 1010 depicts snooper 222 generating and transmitting a partial response to the memory access request snooped at block 1002. In general, the partial response will indicate “Acknowledge” (i.e., availability to service the memory access request), unless snooper 222 does not have resources available to schedule service of the memory access request within a reasonable interval and thus must indicate “Retry”. It should be noted that the use of memory access requests targeting a partial cache line increases the probability of snooper 222 generating an “Acknowledge” partial response in that partial cache line memory accesses utilize less resources (e.g., DRAM banks and data paths) and can be scheduled together with other memory accesses to the same memory block.

The process next passes to block 1016, which illustrates snooper 222 receiving the combined response 410 for the memory access request. As indicated at block 1018, if the combined response 410 includes an indication of “retry”, meaning that the request cannot be fulfilled at the current time and must be retried, the process terminates to block 1030. If, however, snooper 222 determines at block 1018 that the combined response 410 includes an indication of a “success”, the process continues to block 1020. Block 1020 illustrates snooper 222 supplying data to service the memory access request, if indicated by combined response 410.

For example, if the interconnect operation was a partial DCBT and combined response 410 indicated that snooper 222 should supply the target granule, snooper 236 sources only the target granule to the requesting master 232. In at least some embodiments, snooper 222 delivers the data in conjunction with a granule identifier indicating the position of the target granule 307 in the target cache line. Following block 1020, the process ends at block 1030.

In accordance with at least some embodiments of the present invention, processor partial memory access requests, such as DCBT requests, can be utilized not only to cause demand fetching of partial cache lines of data, but also to prime prefetching of partial cache lines of data. Referring now to FIG. 8, there is depicted a more detailed block diagram of an exemplary data prefetch unit (DPFU) 225 in accordance with the present invention. As shown, DPFU 225 includes an address queue 4000 that buffers incoming memory access addresses generated by LSU 228, a prefetch request queue (PRQ) 4004, and a prefetch engine 4002 that generates data prefetch requests 4006 by reference to PRQ 4004.

Prefetch requests 4006 cause data from the memory subsystem to be fetched or retrieved into L1 cache 228 and/or L2 cache 230 preferably before the data is needed by LSU 228. The concept of prefetching recognizes that data accesses frequently exhibit spatial locality. Spatial locality suggests that the address of the next memory reference is likely to be near the address of recent memory references. A common manifestation of spatial locality is a sequential data stream, in which data from a block of memory is accessed in a monotonically increasing (or decreasing) sequence such that contiguous cache lines are referenced by at least one instruction. When DPFU 225 detects a sequential data stream (e.g., references to addresses in adjacent cache lines), it is reasonable to predict that future references will be made to addresses in cache lines that are adjacent to the current cache line (the cache line corresponding to currently executing memory references) following the same direction. Accordingly, DPFU 225 generates data prefetch requests 4006 to retrieve one or more of these adjacent cache lines before the program actually requires them. As an example, if a program loads an element from a cache line n, and then loads an element from cache line n+1, DPFU 225 may prefetch cache some or all of cache lines n+2 and n+3, anticipating that the program will soon load from those cache lines also.

As further depicted in FIG. 8, in at least some embodiments, PRQ 4004 includes a plurality of stream registers 4008. In the depicted embodiment, each stream register 4008 contains several fields describing various attributes of a corresponding sequential data stream. These fields include a valid field 4010, an address field 4012, a direction field 4014, a depth field 4016, a stride field 4018, and optionally, a partial field 4020. Valid field 4010 indicates whether or not the contents of its stream register 4008 are valid. Address field 4002 contains the base address (effective or real) of a cache line or partial cache line in the sequential data stream. Direction field 4014 indicates whether addresses of cache lines in the sequential data stream are increasing or decreasing. Depth field 4016 indicates a number of cache lines or partial cache lines in the corresponding sequential data stream to be prefetched in advance of demand. Stride field 4018 indicates an address interval between adjacent cache lines or partial cache lines within the sequential data stream. Finally, partial field 4020 is a flag indicating whether the stream prefetches partial or full caches lines of prefetch data.

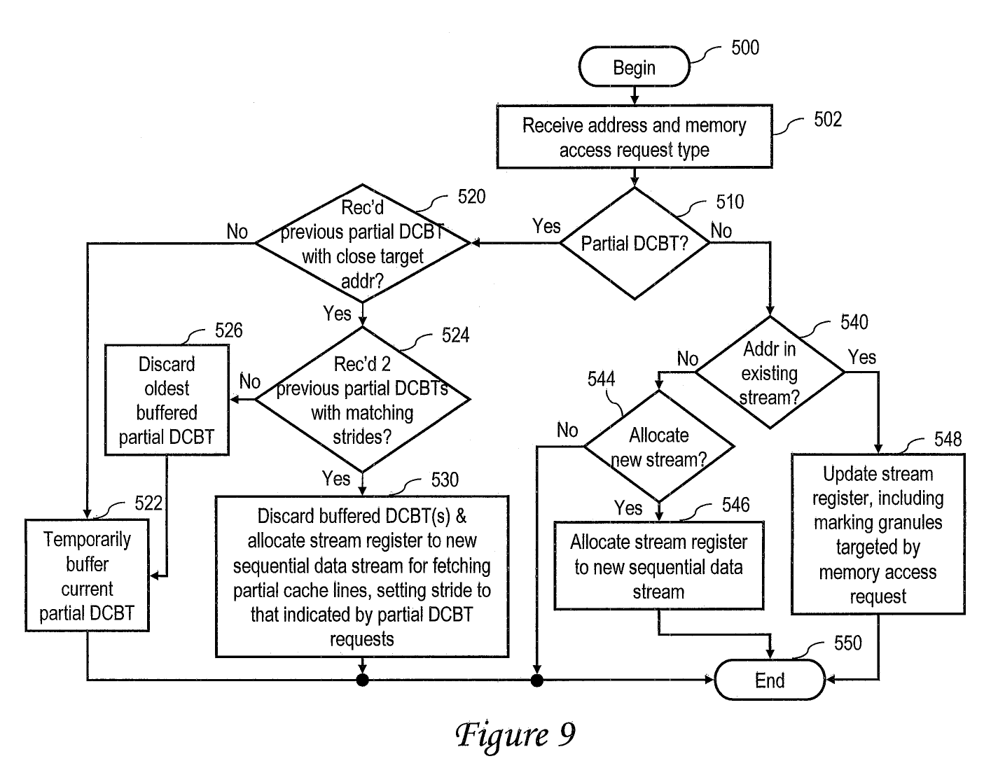

With reference now to FIG. 9, there is depicted a high level logical flowchart of an exemplary process by which DPFU 225 allocates entries in PRQ 4004 in accordance with at least some embodiments of the present invention. The process begins at block 500 and the proceeds to block 502, which depicts DPFU 225 receiving from LSU 228 within address queue 400 a memory access address (e.g., effective or real address) of a demand memory access and an indication of the request type. The process then proceeds to block 510, which depicts prefetch engine 4002 of DPFU 225 determining whether the request type of the demand memory access request is a partial DCBT request. If not, the process proceeds to block 540, which is described below. If, however, the request type of the memory access request is a partial DCBT, the process passes to block 520.

Block 520 depicts prefetch engine 4002 determining whether prefetch engine 4002 has previously received a partial DCBT request that specified a target address that is close to (e.g., within a predetermined range of) the target address of the partial DCBT request received at block 502. If not, prefetch engine 4002 buffers the current partial DCBT request received at block 502 (block 522). Thereafter, the process ends at bock 550.

Returning to block 520, in response to prefetch engine 4002 determining that the target address of the current partial DCBT request received at block 502 was close to the target address of a previously received partial DCBT request, the process proceeds to block 524. Block 524 illustrates prefetch engine 4002 determining whether or not prefetch engine 4002 has received and buffered two previous partial DCBT requests for which the stride between the target addresses of the current DCBT request and the most recently buffered DCBT request matches the stride between the target addresses of the buffered DCBT requests. If not, the prefetch engine 4002 discards the oldest buffered partial DCBT request (block 526) and buffers the current partial DCBT request (block 522). Thereafter, the process ends at block 550.

Returning to block 524, in response to prefetch engine 4002 making an affirmative determination at block 524, meaning that the detected stride between target addresses of partial DCBT requests has been confirmed, the process passes to block 530. Block 530 depicts prefetch engine 4002 discarding the buffered partial DCBT requests and allocating a stream register 4008 to a new sequential data stream for fetching partial cache lines. In allocating the new data stream, prefetch engine 4002 sets fields 4010-4020 of the stream register 4008, including setting stride 4018 to the stride detected by prefetch engine 4002 and setting partial field 4020 to indicate the fetching of partial cache lines. It should be noted that the stride 4018 need not be aligned to a memory block size. Following block 530, the process terminates at block 550.

Referring now to block 540, prefetch engine 4002 determines by reference to PRQ 4004 whether or not the address received at block 502 falls within an existing sequential data stream to which a stream register 4008 has been allocated. If prefetch engine 4002 determines at block 540 that the address belongs to an existing sequential data stream, the process proceeds to block 548, which is described below. If prefetch engine 4002 determines at block 540 that the address does not belong to an existing sequential data stream, prefetch engine 4002 determines at block 544 whether or not to allocate a new sequential data stream, for example, based upon a miss for the memory access address in L1 cache 226, the availability of an unallocated stream register 4008, and/or previous receipt of a closely spaced memory access address.

If prefetch engine 4002 determines to not allocate a new sequential data stream at block 544, the process shown in FIG. 9 simply terminates at block 550. If however, prefetch engine 4002 determines to allocate a new sequential data stream at block 544, prefetch engine 4002 allocates one of stream registers 4008 to the sequential data stream and populates fields 4010-4020 of the allocated stream register 4008. Allocation of the stream register 4008 may entail selection of a stream buffer 4008 based upon, for example, the contents of usage history fields 4020 of stream registers 4008 and/or unillustrated replacement history information indicating a stream register 4008 to be replaced according to a replacement algorithm, such as Least Recently Used (LRU) or round robin. Following block 546, the process terminates at block 550.

Referring now to block 548, in response to a determination that the memory access address received at block 502 falls within an existing sequential data stream to which a stream register 4008 has been allocated in PRQ 4004, prefetch engine 4002 updates the state of the stream register 4008 allocated to the sequential data stream. For example, prefetch engine 4002 may update address field 4012 with the memory access address or modify depth field 4016 or stride field 4018. Following block 548, the process terminates at block 550.

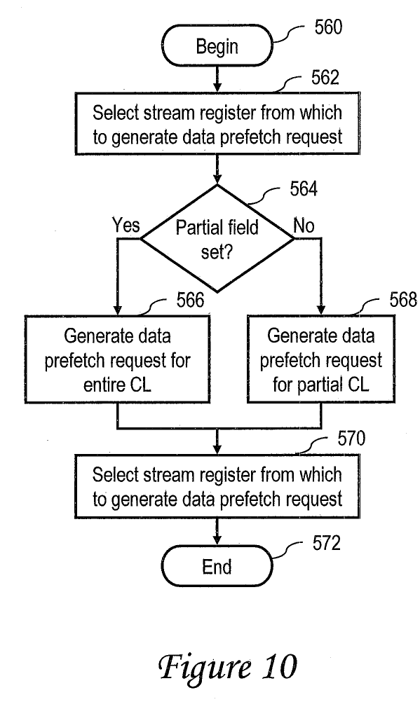

With reference now to FIG. 10, there is illustrated a high level logical flowchart of an exemplary process by which DPFU 225 generates data prefetch requests 4006 in accordance with the present invention. According to at least some embodiments, DPFU 225 issues data prefetch requests 4006 requesting partial cache lines based upon stream registers 4008 specifying the prefetching of partial cache lines (which can be allocated in accordance with FIG. 9).

The process depicted in FIG. 10 begins at block 560 and then proceeds to block 562, which illustrates prefetch engine 4002 selecting a stream register 4008 from which to generate a data prefetch request 4006, for example, based upon demand memory access addresses received from LSU 228 and/or a selection ordering algorithm, such as Least Recently Used (LRU) or round robin. Following selection of the stream register 4008 from which a data prefetch request 406 is to be generated, prefetch engine 4002 determines the amount of data to be requested by the data prefetch request 4006 by reference to the partial field 4020 of the selected stream register 4008 (block 564). In the depicted embodiment, the amount determination is binary, meaning that the data prefetch request 4006 will request either a full cache line (e.g., 128 bytes) or a single predetermined subset of full cache line, such as a single granule (e.g., 32 bytes) based upon the setting of partial field 4020.

In the depicted embodiment, if prefetch engine 4002 determines at block 564 that partial field 4020 does not indicate partial cache line prefetching, prefetch engine 4002 generates a data prefetch request 4006 for a full cache line at block 566. Alternatively, if prefetch engine 4002 determines at block 564 that partial field 4020 indicates partial cache line prefetching, prefetch engine 4002 generates a data prefetch request 4006 for a partial cache line (e.g., indicated by address field 4012 and stride field 4018) at block 568. Following either block 566 or block 568, prefetch engine 4002 transmits the data prefetch request 4006 to the memory hierarchy (e.g., to L2 cache 230 or to IMCs 206) in order to prefetch the target partial or full cache line into cache memory. Thereafter, the process depicted in FIG. 10 terminates at block 572.

As has been described, in at least one embodiment, a processing unit, responsive to a touch request to touch a granule of a cache line of data containing multiple granules, issues on an interconnect a touch operation that requests a copy of the target granule for subsequent query access. The touch request can also trigger prefetching of partial cache lines of data by a data prefetching unit within the processing unit.

While the invention has been particularly shown as described with reference to a preferred embodiment, it will be understood by those skilled in the art that various changes in form and detail may be made therein without departing from the spirit and scope of the invention. For example, although aspects of the present invention have been described with respect to a data processing system, it should be understood that the present invention may alternatively be implemented as a program product comprising program code providing a digital representation of the data processing system and/or directing functions of the data processing system. Program code can be delivered to a data processing system via a variety of computer readable media, which include, without limitation, computer readable storage media (e.g., a computer memory, CD-ROM, a floppy diskette, or hard disk drive), and communication media, such as digital and analog networks. It should be understood, therefore, that such computer readable media, when carrying or storing computer readable instructions that direct the functions of the present invention, represent alternative embodiments of the present invention.

What is claimed is:

1. A method of data processing in a multiprocessor data processing system, said method comprising:
in response to a processor touch request targeting a target granule of a cache line of data containing multiple granules, a processing unit originating on an interconnect of the multiprocessor data processing system a partial touch request that requests a copy of only said target granule for subsequent query access; and
in response to a combined response to said partial touch request indicating success, said combined response representing a system-wide response to said partial touch request, the processing unit receiving said target granule of the target cache line and updating a coherency state of the target granule while retaining a coherency state of at least one other granule of the cache line.

2. The method of claim 1, and further comprising:
determining whether at least the target granule is resident in a cache array of the requesting processor core in a data-valid coherency state;
wherein said originating comprises originating the partial touch request in response to determining that the target granule is not resident in the cache array in a data-valid coherency state.

3. The method of claim 1, wherein originating said partial read request comprises transmitting a granule identifier of the target granule on said interconnect.

4. The method of claim 1, wherein said processing unit is a first processing unit, said method further comprising:
in response to a second processing unit snooping said partial read request, said second processing unit transmitting a copy of only said target granule of said target cache line of data to the first processing unit.

5. The method of claim 1, and further comprising:
at the processing unit, identifying the target granule with a granule identifier and indicating the coherency state of the target granule with a granule coherency state field; and
separately indicating with a line coherency state field a coherency state of at least one other granule of the target cache line.

6. The method of claim 1, and further comprising the processing unit initiating data prefetching of at least one partial cache line in response to the touch request.

7. A processing unit for a multiprocessor data processing system, said processing unit comprising:
an interconnect interface supporting connection to an interconnect of the multiprocessor data processing system;
a processor core that executes instructions including memory access instructions; and
a cache memory coupled to the processor core, said cache memory including a cache array, a cache directory and a master, wherein the master, in response to a processor touch request targeting a target granule of a cache line of data containing multiple granules, originates on an interconnect of the multiprocessor data processing system a partial touch request that requests a copy of only said target granule for subsequent query access, and wherein the master, in response to a combined response to said partial touch request indicating success, said combined response representing a system-wide response to said partial touch request, receives said target granule of the target cache line and updates a coherency state of the target granule while retaining a coherency state of at least one other granule of the cache line.

8. The processing unit of claim 7, wherein said master originates the partial touch request in response to determining that the target granule is not resident in the cache array in a data-valid coherency state.

9. The processing unit of claim 7, wherein said master transmits a granule identifier of the target granule on said interconnect.

10. The processing unit of claim 7, wherein the cache memory includes:
a granule identifier identifying the target granule;
a granule coherency state field indicating the coherency state of the target granule; and
a line coherency state field separately indicating a coherency state of at least one other granule of the target cache line.

11. The processing unit of claim 7, and further comprising the processing unit initiating data prefetching of at least one partial cache line in response to the touch request.

12. A multiprocessor data processing system, comprising:
an interconnect; and
at least first and second processing units coupled to the interconnect, said first processing unit including a first cache memory including a cache array, a cache directory and a master, wherein the master, in response to a processor touch request targeting a target granule of a cache line of data containing multiple granules, originates on an interconnect of the multiprocessor data processing system a partial touch request that requests a copy of only said target granule for subsequent query access, and wherein the master, in response to a combined response to said partial touch request indicating success, said combined response representing a system-wide response to said partial touch request, receives said target granule of the target cache line and updates a coherency state of the target granule while retaining a coherency state of at least one other granule of the cache line.

13. The multiprocessor data processing system of claim 12, wherein said master originates the partial touch request in response to determining that the target granule is not resident in the cache array in a data-valid coherency state.

14. The multiprocessor data processing system of claim 12, wherein said master transmits a granule identifier of the target granule on said interconnect.

15. The multiprocessor data processing system of claim 12, wherein said cache memory includes:
a granule identifier identifying the target granule;
a granule coherency state field indicating the coherency state of the target granule; and
a line coherency state field separately indicating a coherency state of at least one other granule of the target cache line.

16. The multiprocessor data processing system of claim 12, and further comprising the processing unit initiating data prefetching of at least one partial cache line in response to the touch request.

17. The multiprocessor data processing system of claim 12, wherein the second processing unit, in response to snooping said partial touch request, transmits a copy of only said target granule of said target cache line of data to the first processing unit.
